(19) United States
(12) Patent Application Publication
(10) Pub. No.: US 2010/0251622 A1
(43) Pub. Date: Oct. 7, 2010

(54) SLIDER GATE

(76) Inventor: Kenneth John Helfer, Santa Fe, NM (US)

Correspondence Address: Walter A. Michel, 548 Vista De La Ciudad, Santa Fe, NM, 87501-6303, US

(21) Appl. No.: 12/384,174

(22) Filed: Apr. 1, 2009

(51) Int. Cl. E05D 15/16

(52) U.S. Cl. 49/506

(57) ABSTRACT

Standard ground track slide gates roll along a piece of inverted angle iron fastened to the ground the entire length of travel from the fully open to the fully closed position. Typically this is accomplished by a stationary post set on either side of the gate with rollers attached to where the top horizontal frame member passes. With this arrangement of rollers, a situation exists in which there is a heavy steel gate panel moving past two stationary posts. This can be a potentially dangerous situation since the chance of entrapment is a distinct possibility. The present invention describes a method of assembly by someone not necessarily skilled in the art and is intended to solve the problems associated with these safety issues as well as provide the possibility of a more decorative sliding gate

### BACKGROUND OF THE INVENTION

Conventional slide gates, such as those which control access to a parking lot, to a gated community, to private land, or to a garage are installed in one of two basic methods. Cantilever gates are mounted with a set of 4 rollers so that they may be moved horizontally to either open or close the gate without undue effort and are suspended above the gap opening. Ground Track slide gates have a set of 2 “V” groove rollers which roll along a “V” track made of angle iron which is fastened to the ground. The top of the gate is kept level and from falling over by a second set of rollers which pinch the gate between the top horizontal frame member and are loose enough to allow the gate to slide back and forth as it opens and closes. A ground track slide gate is not suspended over the gap opening. The weight of the gate rests completely on the ground track. The gate itself may consist of a long, rectangular framework constructed of metal frames and to this framework is attached a section of fencing which may correspond to that used on the fence. It is the ground track slide gate this invention improves.

Standard ground track slide gates roll along a piece of inverted angle iron fastened to the ground the entire length of travel from the fully open to the fully closed position. This allows for the use of a heavy steel gate without concern of sagging because the entire load is transferred to the ground. However, the gate must be kept upright as it travels back and forth. Typically this is accomplished by a stationary post set on either side of the gate with rollers attached to where the top horizontal frame member passes. These rollers are of sufficient high quality as to not impede travel of the gate and are weather proof.

With this typical arrangement of pinch rollers, a situation exists in which there is a heavy steel gate panel moving past two stationary steel posts. This can be a potentially dangerous situation if a person attempts to reach through the gate for whatever reason and is caught up by the stationary posts. In addition, because the posts are necessarily right up against the moving gate panel, entrapment is a distinct possibility, even without reach through. A loss of balance at an inopportune moment might be all it takes. The present invention is intended to solve the problems associated with these safety issues while supplying a more user friendly means of assembling the gate on site by persons not necessarily skilled in the art as well as creating a more versatile product in the sense of height and decorative options.

Other patents have attempted to either protect a user from potential harm or protect the rollers from damage due to inclement weather. One patent teaches a method of movement which does not require rollers or a guide rail. This is U.S. Pat. No. 4,736,641 which issued Apr. 12, 1988 to James B. Reid and assigned to John Edward Jennings. The patent teaches an improved straight line motion gate mechanism without any moving contact with either the ground or the use of a track. This mechanism appears to be extremely complicated and quite expensive to produce and install. However, the potential for injury is still present. The potential for injury is addressed by U.S. Pat. No. 6,091,217 which issued on Jul. 18, 2000 to Walter Parsadayan and assigned to Elite Access Systems, Inc. This patent discloses the electronic logic for a means of maintaining a safe gate operation. U.S. Pat. No. 5,019,758 which issued on May 28, 1991 to Richard V. Jones and Angel E. Ramirez and assigned to Court Security Systems, Inc. discloses logic circuitry to sense any obstacles and causes the gate to stop and/or reverse much the same as a garage door opener. Patents which also relate to sliding gates but are directed primarily to protecting the rollers from the effects of adverse weather as well as considerations of personal safety would be U.S. Pat. No. 6,751,907 B1 which issued on Jun. 22, 2004 to Joseph De Gasperis and U.S. Pat. No. 5,528,862 which issued to Steven J. Streeter and assigned to Guidance Systems, Inc.

It is an object of the present invention to do away with the pinch roller post scenario and replace it with a guide rail fastened to the back of the gate panel. Two rollers hold the gate upright 18″ away from the moving gate panel eliminating the possibility of inadvertent entrapment. The front of the gate, which typically faces the public, has no stationary post therefore rendering entrapment impossible. The slider guide rail and slider guide also increases the ascetic appeal of the gate panel because they work as well with a decorative arched top gate as they do with a rectangular flat top gate. All these features are presented to the potential purchaser in a form that is easily assembled by someone who is not necessarily skilled in the art and yet the safety features are maintained.

### BRIEF SUMMARY OF THE INVENTION

The present invention is intended to solve the problems associated with safety issues while supplying a more user friendly means of assembling the gate on site by persons not necessarily skilled in the art as well as creating a more versatile product in the sense of height and decorative options.

### BRIEF DESCRIPTION OF SEVERAL VIEWS OF THE DRAWINGS

FIG. 1 depicts the assembly of the gate posts on site.

FIG. 1 a shows the “V” track in concrete and the rollers of the gate

FIG. 2 is a view of the slider gate posts assembly

FIG. 3 is a view of the gate frame assembly

FIG. 4 is an exploded view of FIG. 1 with the safety screens and wheels shown removed.

FIG. 5 is a view of a typical sliding gate assembly showing optional decorative choice.

FIG. 6 is a view of the final assembly with the gate operator and chain.

FIG. 6a shows the chain bolt attached to the chain.

### DESCRIPTION OF THE PREFERRED EMBODIMENT

The following description of a preferred embodiment describes a number of specific structural features to illustrate the concepts and functioning of the means by which the invention may be practiced.

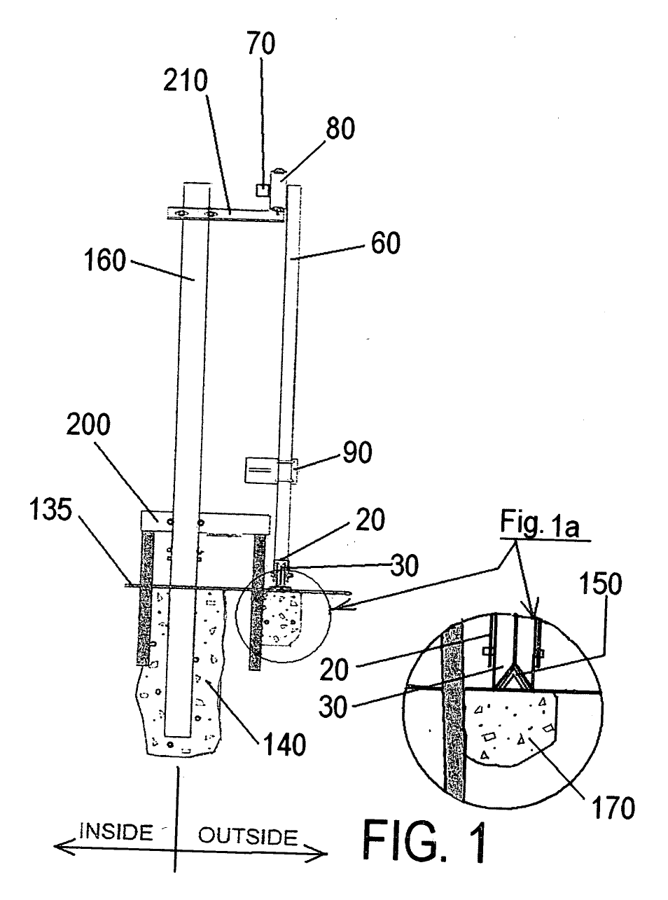

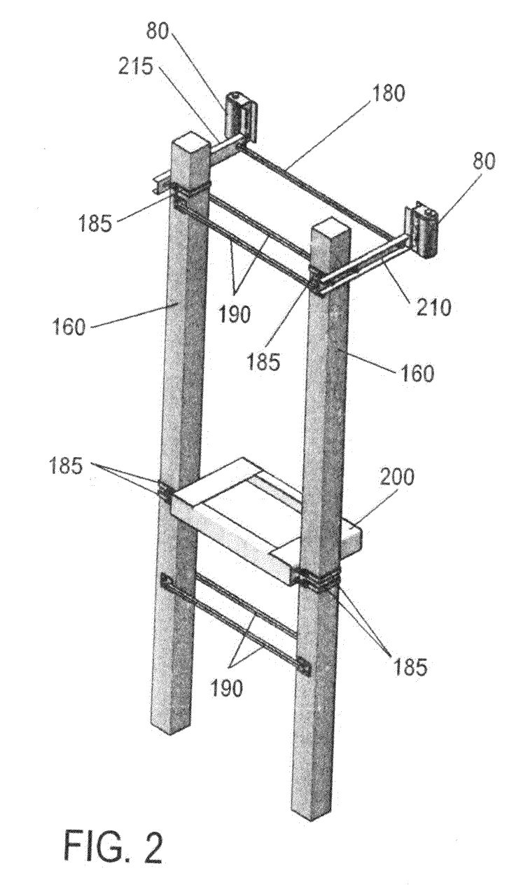

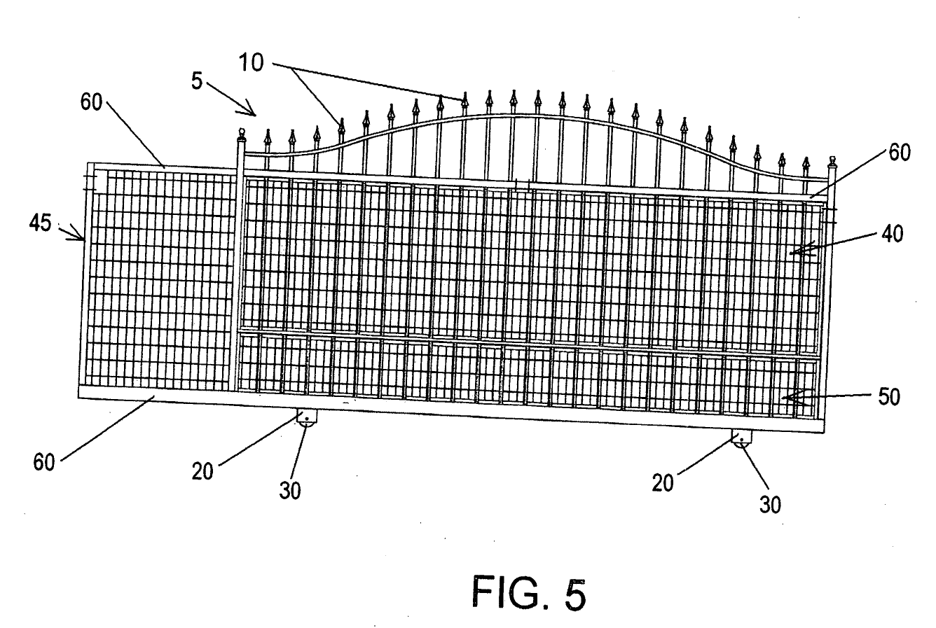

FIG. 1 illustrates many of the requirements for installing the present invention. The initial step in this installation is to establish the location of a slider gate assembly 5, as shown in FIG. 5, and the width of said slider gate assembly 5. With the location established, a grade line must be determined and a grade beam 135 is installed in “V” track concrete 170 (FIG. 1a). A “V” track 150 (FIG. 1a) is then installed the entire length of the grade beam 135 using ⅛ inch concrete anchors. Following this, the slider guide posts 160 should be imbedded in slider guide post concrete 140. During this installation of the slider guide posts 160 the depth in the ground must meet local codes for frost line depth. Also, the slider guide posts 160 must be plumbed level in both directions during installation in the slider guide post concrete 140. Finally, a gate frame 60 can be mounted on the “V” track 150 and held in place by adding reach under arms 210 and 215 as shown in FIG. 2.

FIG. 2 illustrates the slider guide posts 160 which must be securely imbedded in the ground as described in FIG. 1. The distance between the slider guide posts 160 is predetermined by the mounting of an operator platform 200 with U-brackets 185 and square bars 190. The right hand reach under arm 215 and the left hand reach under arm 210 are both mounted with U-brackets 185 and secured with a round bar 180. At the ends of these two reach under arms are mounted guide rollers 80 which will in turn secure the gate frame 60 as shown in FIG. 1.

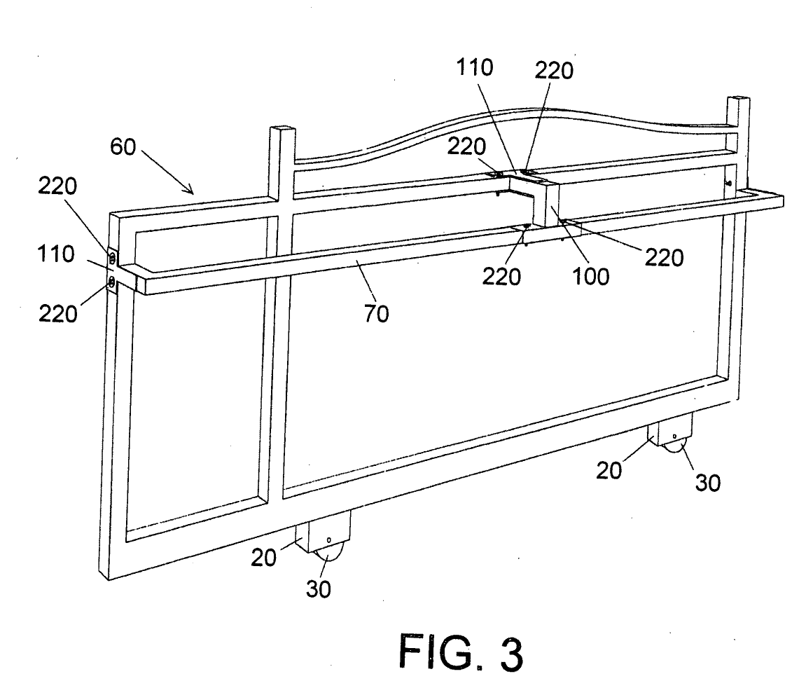

FIG. 3 illustrates the gate frame 60, which is the critical part of the present invention. The construction of this part allows the safety features to be maintained even while final (on site) construction is performed by a person not necessarily skilled in the art. It is important to note the attachment of a guide rail 70 to the gate frame 60 at each end with a guide rail plate 110 and a guide rail attach arm 100 in the center which is also held in place by said guide rail plate 110. These three guide rail plates 110 are mounted by use of pre-drilled holes 220. It will become evident in the later description how this attachment of the guide rail 70 creates the safety features mentioned.

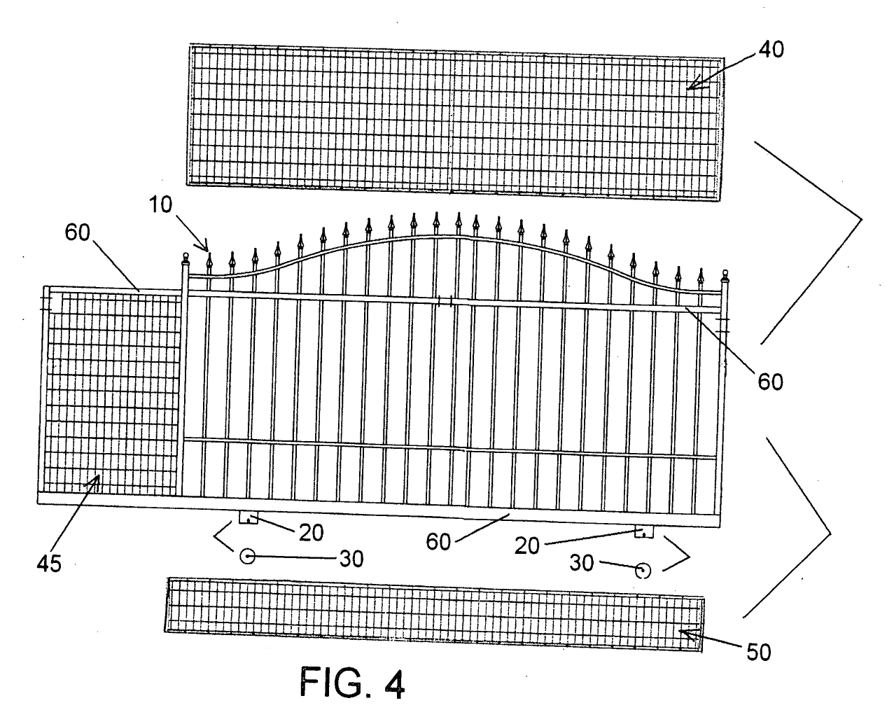

FIG. 4 illustrates the gate frame 60 with a large safety screen 40, a small safety screen 50 and “V” wheels 30, removed, to show a clearer view of gate panel 10, which can take on many decorative forms.

FIG. 5 illustrates the invention assembled and ready for mounting to a slider guide post 160, as shown in FIGS. 1, 2 and 6. The large safety screen 40, small safety screen 50, screen material 45, gate panel 10, wheel box 20 and “V” wheels 30 are all shown mounted to the gate frame 60.

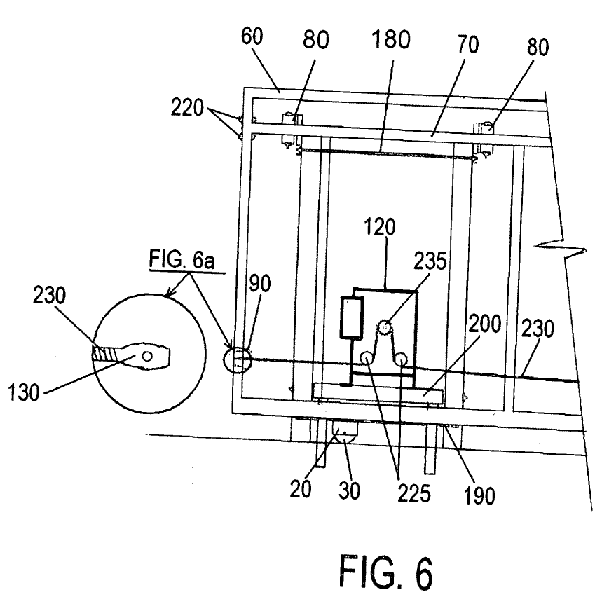

FIG. 6 shows the final steps in the installation of the slider gate assembly 5. The installation of a mechanism for moving the slider gate assembly 5 along the “V” track 150 is next. A gate operator 120 capable of moving said slider gate assembly 5 is mounted on an operator platform 200. There are many such operators available and in this instance, an operator capable of using a chain 230 has been chosen. A chain bolt 130 is secured to the end of the chain 230, as shown in FIG. 6a, which in turn is attached to the gate frame 60 with a chain bracket 90. Such a gate operator 120 would by necessity incorporate a drive sprocket 235 and idler wheels 225 in order to drive the chain 230.

While a particular embodiment and method have been shown, it is to be understood that typical basic elements of this invention have been described and modifications of this embodiment and method will be apparent to those skilled in the art. It is intended that such modifications are included within the definition of the following claims and appended drawings.

What is claimed is:

1. A method of assembling a slider gate on site including safety features which comprises the steps of;
a) determining a grade line;
b) installing a grade beam in concrete;
c) anchoring a “V” track for the entire length of said grade beam;
d) imbedding slider guide posts in concrete;
e) leveling said slider guide posts in all directions;
f) adding right hand and left hand reach under arms to the slider guide posts;
g) mounting a gate frame on said “V” track and
h) securing said gate frame in place with right hand reach under arm and left hand reach under arm.

2. The method of claim 1 wherein the placement of the slider guide posts further comprises the steps of;
a) determining the distance between slider guide posts;
b) mounting of an operator platform between said slider guide posts;
c) mounting and securing said right hand reach under arm and left hand reach under arm and
d) mounting guide rollers at the ends of said right hand reach under arm and said left hand reach under arm.

3. The method of claim 1 wherein said gate frame further comprises the steps of;
a) attaching a guide rail to said gate frame using guide rail plates and a guide rail attach arm;
b) mounting said guide rail plates by use of pre-drilled holes;
c) installing a large safety screen;
d) installing a small safety screen;
e) installing a wheel box and
f) installing “V” wheels in said wheel box.

4. The method of claim 1 wherein assembly of said slider gate further comprises the steps of;
a) mounting a gate operator on said operator platform and
b) installing means by which said gate operator is attached to said slider gate.

5. A method of assembling a slider gate on site including safety and decorative features which comprises the steps of;
a) determining a grade line;
b) installing a grade beam in concrete;
c) anchoring a “V” track for the entire length of said grade beam;
d) imbedding slider guide posts in concrete;
e) leveling said slider guide posts in all directions;
f) adding right hand and left hand reach under arms to the slider guide posts;
g) mounting a decorative gate frame on said “V” track and
h) securing said decorative gate frame in place with said right hand reach under arm and said left hand reach under arm.

6. The method of claim 5 wherein the placement of the slider guide posts further comprises the steps of;
a) determining the distance between slider guide posts;
b) mounting of an operator platform between said slider guide posts;
c) mounting and securing said right hand reach under arm and left hand reach under arm and
d) mounting guide rollers at the ends of said right hand reach under arm and said left hand reach under arm.

7. The method of claim 5 wherein said decorative gate frame further comprises the steps of;
a) attaching a guide rail to said decorative gate frame using guide rail plates and a guide rail attach arm;
b) mounting said guide rail plates by use of pre-drilled holes;
c) installing a large safety screen;
d) installing a small safety screen;
e) installing a wheel box and
f) installing “V” wheels in said wheel box.

8. The method of claim 5 wherein assembly of said slider gate further comprises the steps of;
a) mounting a gate operator on said operator platform and
b) installing means by which said gate operator is attached to said slider gate.
